(19) United States
(12) Patent Application Publication
(10) Pub. No.: US 2007/0103818 A1
(43) Pub. Date: May 10, 2007

(54) Variable resistance element and method of using the same

(75) Inventor: Rachid Sbiaa, Tokyo (JP)

Correspondence Address: OLIFF & BERRIDGE, PLC, P.O. BOX 19928, ALEXANDRIA, VA, 22320, US

(73) Assignees: TDK Corporation, Tokyo (JP); Kabushiki Kaisha Toshiba, Tokyo (JP)

(21) Appl. No.: 11/267,278

(22) Filed: Nov. 7, 2005

(51) Int. Cl. G11B 5/33

(52) U.S. Cl. 360/324.2

(57) ABSTRACT

A variable resistance element whose resistance varies according to a magnitude of current applied thereto, and a method of using the element are provided. The variable resistance element has a first ferromagnetic layer, a second ferromagnetic layer, and a nano-contact portion disposed between the first ferromagnetic layer and the second ferromagnetic layer. The variable resistance element varies in resistance according to the magnitude of a current supplied perpendicularly to the surface of the first and second ferromagnetic layers.

### BACKGROUND OF THE INVENTION

1. Field of the Invention

The present invention relates to a variable resistance element which has a nano-contact portion between two ferromagnetic layers and to a method of using the same.

2. Description of the Related Art

Conventionally, there is known a variable resistance element, such as the TMR (Tunneling Magneto Resistance) and BMR (Ballistic Magneto Resistance) elements, which has first and second ferromagnetic layers stacked together. A direction of magnetization of the first ferromagnetic layer is substantially fixed and a direction of magnetization of the second ferromagnetic layer varies in response to an external magnetic field.

The TMR element has an insulating spacer layer between the first ferromagnetic layer and the second ferromagnetic layer. On the other hand, the first and second ferromagnetic layers of the BMR element is stacked together via a nano-contact portion. In these TMR and BMR elements, a sense current in the direction of thickness experiences the minimum resistance when the direction of magnetization of the second ferromagnetic layer is parallel to that of the first ferromagnetic layer. On the other hand, the sense current in the direction of thickness experiences the maximum resistance when the direction of magnetization of the second ferromagnetic layer is anti-parallel to that of the first ferromagnetic layer. Accordingly, a large difference between the resistances is obtained (e.g., see S. Z. Hua et al., Phys. Review, 2003, B67, 060401(R), and G. Tatara et al., Phys. Review Letters, 1999, Vol. 83, 2030).

There is also known a magnetic element which has a spacer layer disposed between the first ferromagnetic layer of which a direction of magnetization is substantially fixed and the second ferromagnetic layer of which a direction of magnetization is variable. The magnetic element is configured such that the direction of magnetization of the second ferromagnetic layer is selectively changed to be parallel or anti-parallel to that of the first ferromagnetic layer in response to a direction of a current (e.g., see Japanese Patent Laid-Open Publication No. 2005-109263)

The inventor conducted intensive studies to find that a current supplied perpendicularly to the surface of the two ferromagnetic layers, which were connected to each other via a nano-contact portion, caused a change in resistance depending on the magnitude of the current.

### SUMMARY OF THE INVENTION

Various exemplary embodiments of this invention provide a variable resistance element which has a nano-contact portion between two ferromagnetic layers and whose resistance varies according to the magnitude of a current supplied perpendicularly to the surface of these ferromagnetic layers. Various exemplary embodiments of the invention also provide a method of using the variable resistance element.

Various exemplary embodiments of the present invention provide a variable resistance element includes a first ferromagnetic layer, a second ferromagnetic layer, and a nano-contact portion disposed between the first ferromagnetic layer and the second ferromagnetic layer. The variable resistance element varies in resistance according to the magnitude of a current supplied perpendicularly to the surface of the first ferromagnetic layer and second ferromagnetic layer.

As shown in FIG. 5, the variable resistance element is configured such that an increase in a current supplied perpendicularly to the surface of the ferromagnetic layers will cause the resistance to decrease until the current reaches a predetermined value, and a further increase in the current will cause the resistance to increase. That is, the variable resistance element is characterized in that its resistance varies according to the magnitude of the current.

As such, the present invention provides a variable resistance element which allows for varying a magnitude of current supplied perpendicularly to the surface of the ferromagnetic layers, thereby causing a change in resistance of the variable resistance element. Thus, the invention is based on a concept that is totally different from that of the conventional TMR or BMR element whose resistance is varied by an external magnetic field, or that of a magnetic element in which a direction of magnetization of the non-fixed ferromagnetic layer is selectively changed to be parallel or anti-parallel to the fixed ferromagnetic layer according to the direction of the current.

It is not totally clear why the resistance of the variable resistance element varies as a magnitude of a current supplied perpendicularly to the surface of the ferromagnetic layers varies. However, it is envisaged that supplying a current will cause a magnetic wall to be built or moved in the nano-contact portion like the spin transfer effect, thereby causing a variation in resistance of the nano-contact portion.

Accordingly, various exemplary embodiments of the present invention provide

a variable resistance element comprising: a first ferromagnetic layer; a second ferromagnetic layer; and a nano-contact portion disposed between the first and second ferromagnetic layers, the variable resistance element varying in resistance according to the magnitude of a current supplied perpendicularly to the surface of the first ferromagnetic layer and second ferromagnetic layer;

Moreover various exemplary embodiments of the present invention provide

a method of using a variable resistance element which includes a nano-contact portion between a first ferromagnetic layer and a second ferromagnetic layer, in which a current is supplied perpendicularly to the surface of the first ferromagnetic layer and the second ferromagnetic layer to vary the resistance of the variable resistance element according to the magnitude of the current; and

As used herein, the term “nano-contact portion” is defined as a portion which is nano-sized (with the maximum width of approximately 0.3 to 3 nm) and connects the two ferromagnetic layers together magnetically and electrically.

The variable resistance element according to the present invention varies in resistance according to the magnitude of a current supplied perpendicularly to the surface of the ferromagnetic layers.

### BRIEF DESCRIPTION OF THE DRAWINGS

FIG. 1 is an enlarged schematic sectional view showing a variable resistance element according to a first exemplary embodiment of the present invention;

FIG. 2 is an enlarged sectional view showing a nano-contact portion in the first exemplary embodiment;

FIG. 3 is a flowchart showing the steps of manufacturing the variable resistance element;

FIG. 4A is a schematic side view showing a step to deposit Al film on a second ferromagnetic layer;

FIG. 4B is a schematic side view showing the Al film deposited on the second ferromagnetic layer;

FIG. 4C is a schematic side view showing a step to oxidize the Al film;

FIG. 4D is a schematic side view showing a state where a first ferromagnetic layer is deposited on the Al film;

FIG. 5 is a graph showing changes in resistance of the variable resistance element plotted against the magnitude of the current applied thereto being varied;

FIG. 6 is a schematic circuit diagram showing the configuration of an actuator according to a second exemplary embodiment of the present invention;

FIG. 7 is a schematic circuit diagram showing the configuration of a transmitter according to a third exemplary embodiment of the present invention; and

FIG. 8 is a schematic circuit diagram showing the configuration of a recording device according to a fourth exemplary embodiment of the present invention.

### DETAILED DESCRIPTION OF THE PREFERRED EMBODIMENTS

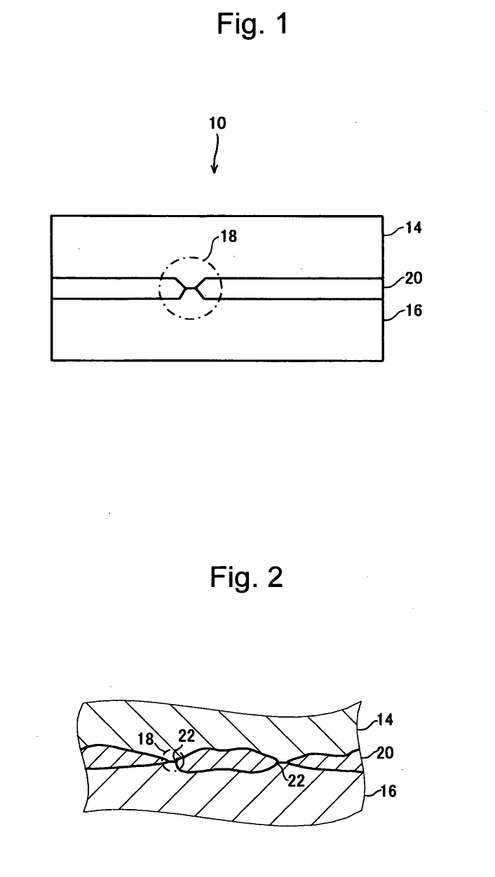

As shown in FIG. 1, a variable resistance element 10 according to a first exemplary embodiment of the present invention has a first ferromagnetic layer 14, a second ferromagnetic layer 16, and a nano-contact portion 18 disposed between the first ferromagnetic layer 14 and the second ferromagnetic layer 16. The variable resistance element 10 is configured to vary in resistance according to the magnitude of a current supplied perpendicularly to the surface of the first ferromagnetic layer 14 and the second ferromagnetic layer 16.

The first ferromagnetic layer 14 and the second ferromagnetic layer 16 have a magnetic single layer structure, a combined structure (made up of at least two ferromagnetic layers, coupled to each other anti-ferromagnetically, with the layers separated by a non-magnetic spacer of Ru, Rh, Ir, Cr, Cu or the like), or a multi-layer structure including two layers or more such as CoFe/NiFe. The ferromagnetic layer represented by CoFe/NiFe means a multi-layer structure including two layers stacked together, i.e., a CoFe layer substantially consist of Co and Fe, and a NiFe layer substantially consist of Ni and Fe. It is possible to use, as material for the first ferromagnetic layer 14 and the second ferromagnetic layer 16, CoFe, CoFeB, NiFe, CoNi, CoFeNi, CoMnAl, NiMnSb, material essentially consisting of Co, Cr, Fe, and Al such as Co₂Cr_{0.6}Fe_{0.4}Al, material essentially consisting of Co, Cr, and Al such as Co₂Cr_{0.6}Al, material essentially consisting of Co, Mn, and Al such as Co₂MnAl, material essentially consisting of Co, Fe, and Al such as Co₂FeAl, material essentially consisting of Co, Mn, and Ge such as Co₂MnGe or the like.

The nano-contact portion 18 is formed in a thin film 20 which is made of an electrically insulating metal oxide and which has a thickness of approximately 1 nm or less. As shown in FIG. 2, the thin film 20 includes one or more nano-size defects 22. A part of the material of either one of the first ferromagnetic layer 14 and the second ferromagnetic layer 16 stays in the defect 22 to connect to the material of the other to form the nano-contact portion 18.

More specifically, the thin film 20 is made up of a thin film of a metal oxide oxidized with plasma using oxygen and has a thickness of 4 to 12 angstroms. It is possible to use, as material for the thin film 20, Al₂O₃, TiO₂, MgO, HfO₂ or the like. Furthermore, the thin film 20 includes a defect 22 having a maximum diameter of 0.3 to 3 nm at one or more sites therein.

Part of the material of the second ferromagnetic layer 16 has migrated into the defect 22 and stays therein to form the nano-contact portion 18 to contact with the first ferromagnetic layer 14 from the defect 22. The defects 22 are randomly formed in the thin film 20.

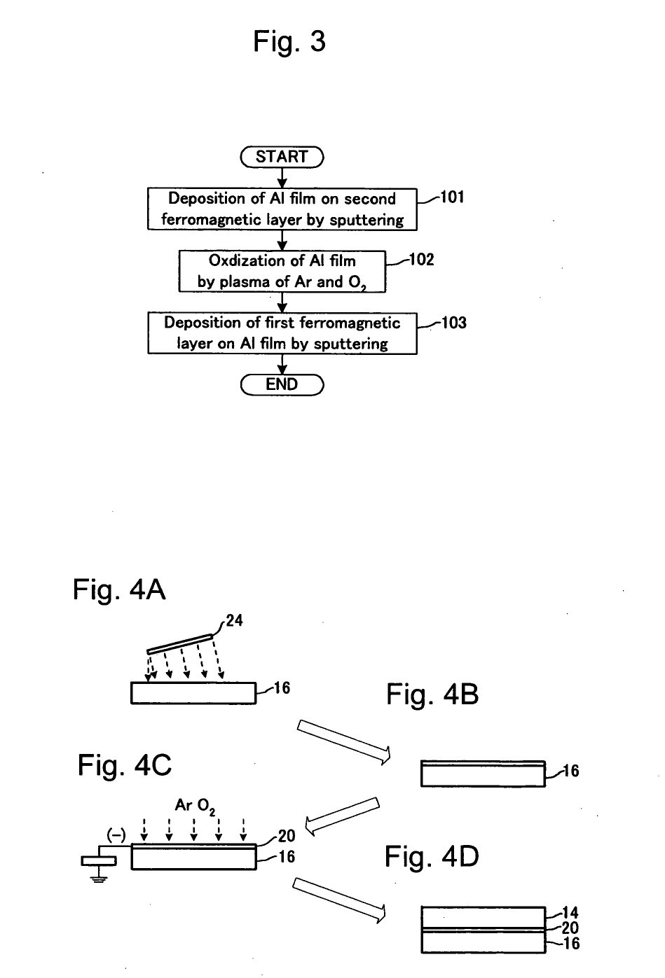

Now, a description will be made in detail to a method of manufacturing the variable resistance element 10 with reference to FIGS. 3 and 4A to 4D.

At step 101 in FIG. 3, as shown in FIG. 4A, an Al film is deposited on the second ferromagnetic layer 16 by sputtering using an aluminum target 24 (see FIG. 4B). In this step, the thickness of the film is aimed at 8±4 angstroms. The Al film deposited in a thickness of approximately 1 nm or less in the manner mentioned above will end up with a non-continuous film that has defects 22 at several sites, as shown in FIG. 2. The defect 22 is 0.3 to 3 nm in size.

Then, as shown in FIG. 4C, the process proceeds to step 102, where the Al film is oxidized by plasma using Ar and O₂ gases. At this step, an acceleration voltage of −200 V is preferably applied to the Al film at the same time (in which the chamber is grounded with the negative potential applied to the Al film), with the flow of the O₂ gas being 5 sccm to 10 sccm and the flow ratio (mole ratio) of Ar to O₂ being 0.8. The acceleration voltage may be to range from −100 to −500 V, more preferably, from −150 to −300 V.

Here, the mole fraction of the Ar gas to the O₂ gas, used for the oxidation by plasma, may be 0.3 to 2, more preferably, 0.5 to 1.5.

For example, the period of time for oxidation may be 40 to 120 seconds, and more preferably 40 to 60 seconds. This period of time is useful to prevent the thin film 20 from excessively being oxidized. The oxidation process may be preferably carried out in one step within the aforementioned period of time, but may also be performed in a plurality of steps.

The negative voltage applied to the Al film as mentioned above will cause Ar⁺ ions in the plasma to be strongly attracted and bombarded to the Al film. Then, the energy of the Ar⁺ ions increases the probability of the thin film 20 being oxidized, allowing the ferromagnetic material forming the second ferromagnetic layer 16, on which the thin film 20 is deposited, to migrate into the aforementioned defect 22.

Then, at step 103, as shown in FIG. 4D, a ferromagnetic material (e.g., CoFe or CoFeB) is mainly deposited on the thin film 20 by sputtering to form the first ferromagnetic layer 14.

This allows the material of the second ferromagnetic layer 16 having migrated into the defect 22, which penetrates the thin film 20, to be connected to the first ferromagnetic layer 14 to form the nano-contact portion 18.

With the variable resistance element 10 formed as described above, a current was supplied perpendicularly to the surface of the first ferromagnetic layer 14 and the second ferromagnetic layer 16. It was then observed that the electrical resistance of the variable resistance element 10 was varied according to the magnitude of the current.

To supply the current in a direction generally perpendicular to the film surface of the aforementioned element, a pair of electrodes was formed (not shown) so as to sandwich the element therebetween. The first ferromagnetic layer 14 or the second ferromagnetic layer 16 can also be formed on the substrate via a buffer layer. A known structure such as a cap layer or a bias layer can also be provided.

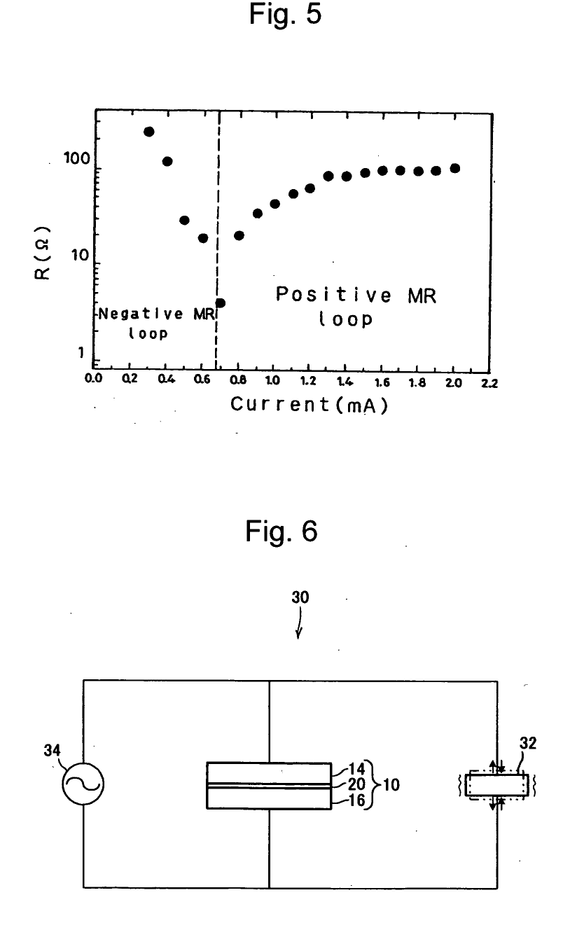

With the variable resistance element 10 according to the first exemplary embodiment, FIG. 5 shows the resistance of the variable resistance element 10 obtained at each current. The resistance was obtained by applying an external magnetic field in a direction perpendicular to the direction of thickness of the first ferromagnetic layer 14 and the second ferromagnetic layer 16 to thereby magnetize the first ferromagnetic layer 14 and the second ferromagnetic layer 16 in the same direction. From FIG. 5, it can be seen that a change of the magnitude of the current causes a variation in resistance of the variable resistance element 10 in a manner such that the resistance exhibits the minimum value at a predetermined current (at approximately 0.7 mA in the first exemplary embodiment).

In the first exemplary embodiment, the resistance of the variable resistance element 10 was measured with the first ferromagnetic layer 14 and the second ferromagnetic layer 16 magnetized in the same direction. However, even when the directions of magnetization of the first ferromagnetic layer 14 and the second ferromagnetic layer 16 are different from each other, e.g., when the directions of magnetization of the first ferromagnetic layer 14 and the second ferromagnetic layer 16 are anti-parallel to each other, the resistance of the variable resistance element 10 varies according to the magnitude of the current.

Furthermore, in the first exemplary embodiment, an external magnetic field was applied in a direction perpendicular to the direction of thickness of the first ferromagnetic layer 14 and the second ferromagnetic layer 16 to restrict the direction of magnetization of the first ferromagnetic layer 14 and the second ferromagnetic layer 16. However, for example, an anti-ferromagnetic layer may also be disposed in contact with one or both of the first ferromagnetic layer and the second ferromagnetic layer, thereby fixing the direction of magnetization of the first ferromagnetic layer and the second ferromagnetic layer.

Furthermore, even without fixing the direction of magnetization of the first ferromagnetic layer and the second ferromagnetic layer, the resistance of the variable resistance element 10 will vary according to the magnitude of current. In this case, it is preferable that at least one of the first ferromagnetic layer and the second ferromagnetic layer is magnetized in one direction perpendicular to the direction of thickness.

Now, a description will be made to a second exemplary embodiment of the present invention.

The second exemplary embodiment relates to an actuator 30 as shown in FIG. 6. The actuator 30 is configured such that a piezoelectric element 32 is connected in parallel to the variable resistance element 10 according to the first exemplary embodiment, such that an AC voltage is applied thereto from an AC power supply 34.

With the actuator 30, a current supplied to the variable resistance element 10 varies in magnitude in synchronization with the cycle of the AC voltage, thereby causing a change in resistance of the variable resistance element 10. Accordingly, a variation in the AC current supplied to the piezoelectric element 32 is amplified, thereby providing a large displacement in the piezoelectric element 32.

Now, a description will be made to a third exemplary embodiment of the present invention.

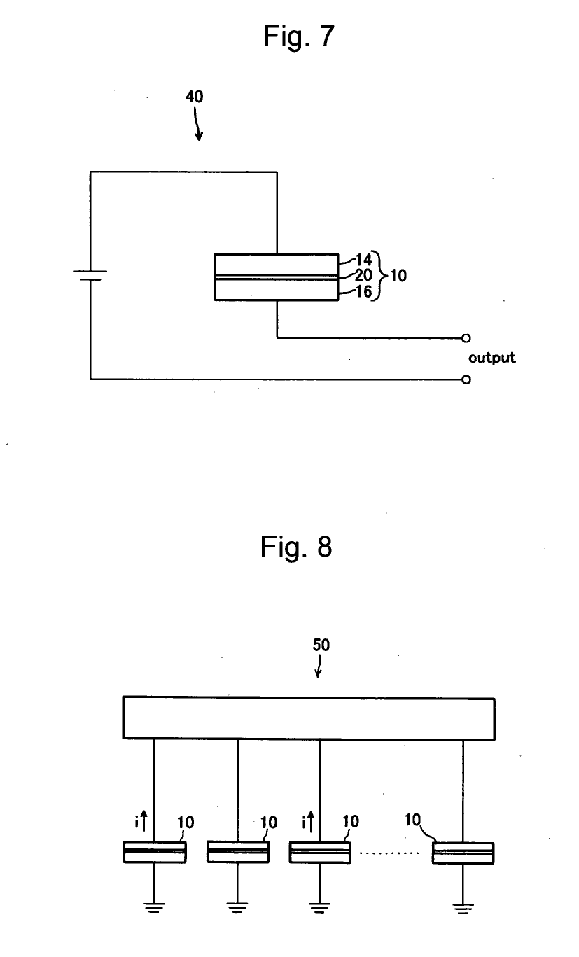

The third exemplary embodiment relates to a transmitter 40 as shown in FIG. 7. With the transmitter 40, a DC power supply 42 is connected to the variable resistance element 10 according to the first exemplary embodiment to provide an output between the variable resistance element 10 and the DC power supply 42. The transmitter 40 provides an AC output with a certain frequency because the resistance of the variable resistance element 10 varies according to the magnitude of the current supplied to the variable resistance element 10.

Now, a description will be made to a fourth exemplary embodiment.

The fourth exemplary embodiment relates to a recording device 50 as shown in FIG. 8. The recording device 50 includes a plurality of variable resistance elements 10 according to the first exemplary embodiment. The recording device 50 can supply a current of a predetermined magnitude to each of the variable resistance elements 10 to thereby vary the resistance of each variable resistance element 10, in order to record information as a combination of the resistances of the variable resistance elements 10.

1. A variable resistance element comprising:
a first ferromagnetic layer;
a second ferromagnetic layer; and
a nano-contact portion disposed between the first ferromagnetic layer and the second ferromagnetic layer, wherein
the variable resistance element varies in resistance according to a magnitude of a current supplied perpendicularly to a surface of the first ferromagnetic layer and second ferromagnetic layer.

2. The variable resistance element according to claim 1, wherein
the resistance varies according to a magnitude of a current of 2 mA or less supplied as the current.

3. The variable resistance element according to claim 1, wherein
the nano-contact portion has a maximum width of 3 nm or less.

4. A method of using a variable resistance element which includes a nano-contact portion between a first ferromagnetic layer and a second ferromagnetic layer, the method comprising supplying the element with a current perpendicularly to a surface of the first ferromagnetic layer and the second ferromagnetic layer to vary a resistance of the variable resistance element according to a magnitude of the current.

5. The method of using a variable resistance element according to claim 4, wherein
a current of 2 mA or less is supplied as the current.

6. The variable resistance element according to claim 2, wherein
the nano-contact portion has a maximum width of 3 nm or less.
